(19) United States
(12) Patent Application Publication
(10) Pub. No.: US 2025/0170629 A1
(43) Pub. Date: May 29, 2025

(54) METHOD FOR CATALYTIC DEGRADATION OF ORGANIC WASTE

(71) Applicants: Nankai University, Tianjin (CN); Kashi University, Xinjiang Uygur Autonomous Region (CN); Chongqing Waiyu Technology Co., Ltd., Chongqing (CN)

(72) Inventors: Weizun LI, Tianjin (CN); Mingyan YU, Tianjin (CN); Xiaoping LIU, Tianjin (CN); Chen PAN, Tianjin (CN); Wei WANG, Tianjin (CN); Xianghao ZHA, Tianjin (CN)

(21) Appl. No.: 18/593,172

(22) Filed: Mar. 1, 2024

(30) Foreign Application Priority Data
Nov. 23, 2023 (CN) 2023115725582

(51) Int. Cl. B09B 3/70; B01D 47/06; B01D 53/32; B01J 27/24; B01J 35/33; B01J 37/04; B01J 37/08; B01J 37/34; B09B 3/40; B09B 101/70; B09B 101/75; B09B 101/85

(52) U.S. Cl. CPC B09B 3/70; B01D 47/06; B01D 53/32; B01J 27/24; B01J 35/33; B01J 37/04; B01J 37/086; B01J 37/343; B09B 3/40; B09B 2101/70; B09B 2101/75; B09B 2101/85

(57) ABSTRACT

Provided is a method for catalytic degradation of an organic waste. The method for catalytic degradation of an organic waste provided by the disclosure includes: step (1) under a condition of a closed micro-oxygen environment, mixing the organic waste with a magnetic thermally conductive catalyst to obtain a mixture, and subjecting the mixture to catalytic degradation to obtain a catalytically degraded gas, a catalytically degraded suspended particulate matter, and a catalytically degraded solid; and step (2) purifying the catalytically degraded gas and the catalytically degraded suspended particulate matter obtained in step (1), then discharging, and subjecting the catalytically degraded solid obtained in step (1) to magnetic separation to obtain an ash and a recovered magnetic thermally conductive catalyst; wherein the catalytic degradation is conducted at a temperature of 200° C. to 250° C. for 15 h to 24 h.

### CROSS REFERENCE TO RELATED APPLICATION

This patent application claims the benefit and priority of Chinese Patent Application No. 2023115725582 filed with the China National Intellectual Property Administration on Nov. 23, 2023 and entitled with “METHOD FOR CATALYTIC DEGRADATION OF ORGANIC WASTE”, the disclosure of which is incorporated by reference herein in its entirety as part of the present application.

### TECHNICAL FIELD

The present disclosure relates to the technical field of the degradation of organic wastes, and in particular to a method for catalytic degradation of an organic waste.

### BACKGROUND

Currently, there are problems with the disposal of rural household wastes due to incomplete infrastructure construction and high investment costs. Although a three-level disposal mode of “village collection, township transfer, and county treatment” has been established, the existing waste collection and treatment mode has the following disadvantages: From the perspective of an economic cost, the large rural area and scattered waste distribution cause problems such as long transportation distance, large land use for waste disposal, high collection and transportation costs, and high infrastructure construction costs. From the perspective of social and environmental impacts, the random dumping and stacking of household wastes and the inability to remove and transport them in time are very easy to cause secondary pollution to surrounding environments including water, soil, and air. In addition, the breeding of mosquitoes and flies and stench also seriously affects the rural living environment and lays troubles for the health of villagers. From the perspective of disposal technologies, 5t/d waste incineration facilities are constructed, but cannot operate normally due to high waste transportation and collection costs and small waste production. The landfill mode takes up a lot of land resources and involves high costs for leakage prevention and leachate treatment. China supports landfill disposal after minimization, so direct landfill of household waste is no longer suitable for China's current social development.

Therefore, it has become an urgent problem to be solved in the art to provide a method for catalytic degradation of an organic waste, which can realize the on-site disposal of organic wastes in daily life without causing other pollutions.

### SUMMARY

An object of the present disclosure is to provide a method for catalytic degradation of an organic waste, which can quickly realize the catalytic degradation of an organic waste at a relatively-low temperature without producing harmful substances such as dioxins, and can also realize the on-site disposal of an organic waste in daily life. The method is simple, easy to implement, and cost-effective.

To achieve the above object, the present disclosure provides the following technical solutions:

The present disclosure provides a method for catalytic degradation of an organic waste, including:
step (1) under a condition of a closed micro-oxygen environment, mixing the organic waste with a magnetic thermally conductive catalyst to obtain a mixture, and subjecting the mixture to catalytic degradation to obtain a catalytically degraded gas, a catalytically degraded suspended particulate matter, and a catalytically degraded solid; and
step (2) purifying the catalytically degraded gas and the catalytically degraded suspended particulate matter obtained in step (1), then discharging, and subjecting the catalytically degraded solid obtained in step (1) to magnetic separation to obtain an ash and a recovered magnetic thermally conductive catalyst;
wherein the catalytic degradation is conducted at a temperature of 200° C. to 250° C. for 15 h to 24 h.

In some embodiments, in step (1), the closed micro-oxygen environment has an oxygen concentration of 0.01 mL/L to 0.1 mL/L.

In some embodiments, in step (1), a mass ratio of the organic waste to the magnetic thermally conductive catalyst is in a range of (90-110):(1-5).

In some embodiments, in step (1), the organic waste includes one or more selected from the group consisting of a waste plastic, a waste paper, a kitchen waste, a waste wood product, and a waste nylon material.

In some embodiments, in step (1), the magnetic thermally conductive catalyst is a carbon and nitrogen-doped Fe₃O₄—MgO catalyst.

In some embodiments, the carbon and nitrogen-doped Fe₃O₄—MgO catalyst is prepared by a process including the following steps:
step 1) mixing an iron salt, a magnesium salt aqueous solution, and a dicyandiamide aqueous solution to obtain a mixture, and then drying the mixture to obtain an iron-magnesium-dicyandiamide complex; and
step 2) calcining the iron-magnesium-dicyandiamide complex obtained in step 1) to obtain the carbon and nitrogen-doped Fe₃O₄—MgO catalyst.

In some embodiments, in step 1), a ratio of a mass of the iron salt to a total volume of the magnesium salt aqueous solution and the dicyandiamide aqueous solution is in a range of (0.05-0.15) g:(1-2) L.

In some embodiments, in step 2), the calcining is conducted at a temperature of 500° C. to 600° C. for 2.5 h to 3.5 h.

In some embodiments, in step (1), a heating for the catalytic degradation is carried out by light wave irradiation, and the light wave irradiation is conducted with a wavelength of 170 nm to 180 nm and an intensity of 60 mW/m² to 70 mW/m².

In some embodiments, in step (2), purifying the catalytically degraded gas includes: subjecting the catalytically degraded gas to washing spray, electric capture tar, and low-temperature plasma treatment successively.

The method for catalytic degradation of an organic waste provided by the present disclosure includes: under a condition of a closed micro-oxygen environment, mixing the organic waste with a magnetic thermally conductive catalyst to obtain a mixture, and subjecting the mixture to catalytic degradation to obtain a catalytically degraded gas, a catalytically degraded suspended particulate matter, and a catalytically degraded solid; and purifying the catalytically degraded gas and the catalytically degraded suspended particulate matter, then discharging, and subjecting the catalytically degraded solid to magnetic separation to obtain an ash and a recovered magnetic thermally conductive catalyst; wherein the catalytic degradation is conducted at a temperature of 200° C. to 250° C. for 15 h to 24 h. In the present disclosure, H₂O is activated under the catalytic action of the magnetic thermally conductive catalyst to form OH⁻ free radicals and oxygen free radicals to effectively promote the full decomposition; and at the same time, the micro-oxygen environment and the low temperature will not cause other side reactions to produce harmful substances such as dioxins. In addition, the magnetic thermally conductive catalyst has an excellent heat-conducting effect, can effectively activate the organic waste at a low temperature of 200° C. to 250° C., and accelerate the friction and collision among molecules, thereby realizing the rapid, effective, and harmless on-site disposal of the organic waste. The method is simple, does not require the long-distance transportation of rural wastes to a specific waste disposal station in a city, and has a low cost. Moreover, the magnetic thermally conductive catalyst can be recovered based on its magnetic characteristics, thereby realizing the recycling of the magnetic thermally conductive catalyst.

The results of examples show that, when the method provided by the present disclosure is used for catalytic degradation of an organic waste, the ash ignition loss is in a range of 2.6% to 2.8%, and when the final product is discharged, the pollutant contents in the final products are as follows: suspended particulate matter: 18 mg/m³ to 25 mg/m³; NOₓ: 90 mg/m³ to 110 mg/m³; SO₂: 30 mg/m³ to 50 mg/m³; HCl: less than or equal to 21 mg/m³; CO: 70 mg/m³ to 80 mg/m³; Hg and a compound thereof (a content of the compound is calculated in terms of Hg): 0.01 mg/m³ to 0.02 mg/m³; cadmium, thallium, and a compound thereof (a content of the compound is calculated in terms of Cd+Tl): 0.02 mg/m³ to 0.03 mg/m³; antimony, arsenic, lead, chromium, cobalt, copper, manganese, nickel, and a compound thereof (a content of the compound is calculated in terms of Sb+As+Pb+Cr+Co+Cu+Mn+Ni): less than or equal to 0.2 mg/m³; and dioxin: 0.001 ngTEQ/m³ to 0.03 ngTEQ/m³. The pollutant contents in the catalytic degradation products all meet the emission standards in the “Standard for Pollution control on the Municipal Solid Waste Incineration” (GB 18485-2014).

### DETAILED DESCRIPTION OF THE EMBODIMENTS

The present disclosure provides a method for catalytic degradation of an organic waste, including:
step (1) under a condition of a closed micro-oxygen environment, mixing the organic waste with a magnetic thermally conductive catalyst to obtain a mixture, and subjecting the mixture to catalytic degradation to obtain a catalytically degraded gas, a catalytically degraded suspended particulate matter, and a catalytically degraded solid; and
step (2) purifying the catalytically degraded gas and the catalytically degraded suspended particulate matter obtained in step (1), then discharging, and subjecting the catalytically degraded solid obtained in step (1) to magnetic separation to obtain an ash and a recovered magnetic thermally conductive catalyst;
wherein the catalytic degradation is conducted at a temperature of 200° C. to 250° C. for 15 h to 24 h.

In the present disclosure, under a condition of a closed micro-oxygen environment, the organic waste is mixed with a magnetic thermally conductive catalyst to obtain a mixture, and the mixture is subjected to catalytic degradation to obtain a catalytically degraded gas, an catalytically degraded suspended particulate matter, and a catalytically degraded solid.

In some embodiments of the present disclosure, the closed micro-oxygen environment has an oxygen concentration of 0.01 mL/L to 0.1 mL/L, and preferably 0.03 mL/L to 0.08 mL/L. In the present disclosure, by controlling the oxygen concentration of the closed micro-oxygen environment within the above range, organic macromolecules in the organic waste can be oxidized so that the carbon chains of the organic macromolecules are broken to produce small molecule substances, which is more conducive to the full decomposition of the organic waste.

In some embodiments of the present disclosure, a mass ratio of the organic waste to the magnetic thermally conductive catalyst is in a range of (90-110):(1-5), and preferably (95-105):(2-4). In the present disclosure, by controlling the dosage of the magnetic thermally conductive catalyst within the above range, the full contact of the organic waste with the magnetic thermally conductive catalyst can be ensured, thereby realizing the catalytic degradation of the organic waste.

In some embodiments of the present disclosure, the organic waste includes one or more selected from the group consisting of a waste plastic, a waste paper, a kitchen waste, a waste wood product, and a waste nylon material.

In some embodiments of the present disclosure, the magnetic thermally conductive catalyst is a carbon and nitrogen-doped Fe₃O₄—MgO catalyst. In the present disclosure, by adopting the carbon-nitrogen doped Fe₃O₄—MgO catalyst, the Fe₃O₄ in the catalyst can be used to make the catalyst have magnetic properties, thereby realizing the recovery and recycling of the magnetic thermally conductive catalyst, further reducing the cost and also being conducive to environmental protection. Moreover, the carbon and nitrogen-doped Fe₃O₄—MgO catalyst has thermal conductivity to some extent, which can transfer the temperature in the organic waste at a low temperature and realize the rapid degradation of the organic waste.

In some embodiments of the present disclosure, the carbon and nitrogen-doped Fe₃O₄—MgO catalyst is prepared by a process including the following steps:
step 1) mixing an iron salt, a magnesium salt aqueous solution, and a dicyandiamide aqueous solution to obtain a mixture, and then drying the mixture to obtain an iron-magnesium-dicyandiamide complex; and
step 2) calcining the iron-magnesium-dicyandiamide complex obtained in step 1) to obtain the carbon and nitrogen-doped Fe₃O₄—MgO catalyst.

In the present disclosure, an iron salt, a magnesium salt aqueous solution, and a dicyandiamide aqueous solution are mixed to obtain a mixture, and then the mixture is dried to obtain an iron-magnesium-dicyandiamide complex.

In some embodiments of the present disclosure, the iron salt is a mixture of Fe(NO₃)₂ and Fe(NO₃)₃.

In some embodiments of the present disclosure, the mixture of Fe(NO₃)₂ and Fe(NO₃)₃ is prepared by a process including the following steps: mixing an Fe(NO₃)₂ aqueous solution with an Fe(NO₃)₃ aqueous solution to obtain a mixed solution and subjecting the mixed solution to ultrasonic treatment and drying to obtain the mixture of Fe(NO₃)₂ and Fe(NO₃)₃. There are no special requirements for the specific operation of the mixing, ultrasonic treatment, and drying, and conventional methods in the art may be adopted. In the present disclosure, by adopting the mixture of Fe(NO₃)₂ and Fe(NO₃)₃ prepared by the above process, it can be ensured that Fe²⁺ and Fe³⁺ are uniformly mixed, which is more conducive to obtaining a magnetic thermally conductive catalyst having excellent catalytic performance and ensuring the complete catalytic degradation of an organic waste.

In some embodiments of the present disclosure, the Fe(NO₃)₂ aqueous solution has a concentration of 0.05 mol/L to 0.15 mol/L, and preferably 0.1 mol/L; and the Fe(NO₃)₃ aqueous solution has a concentration of 0.05 mol/L to 0.15 mol/L, and preferably 0.1 mol/L. In some embodiments of the present disclosure, a volume ratio of the Fe(NO₃)₂ aqueous solution to the Fe(NO₃)₃ aqueous solution is in a range of 2:(3-5). In the present disclosure, by controlling the respective concentrations of the Fe(NO₃)₂ aqueous solution and the Fe(NO₃)₃ aqueous solution and the volume ratio of the two within the above ranges, Fe²⁺ and Fe³⁺ can have a suitable ratio to produce Fe₃O₄, which is more conducive to obtaining a magnetic thermally conductive catalyst having excellent catalytic performance and ensuring that the full catalytic degradation of an organic waste can be realized.

In some embodiments of the present disclosure, the magnesium salt aqueous solution is a Mg(NO₃)₂ aqueous solution, and the Mg(NO₃)₂ aqueous solution has a concentration of 0.1 mol/L to 0.3 mol/L, and preferably 0.2 mol/L. In some embodiments of the present disclosure, the dicyandiamide aqueous solution has a concentration of 0.05 mol/L to 0.15 mol/L, and preferably 0.1 mol/L. In some embodiments of the present disclosure, a volume ratio of the Mg(NO₃)₂ aqueous solution to the dicyandiamide aqueous solution is in a range of 1:(3-5). In the present disclosure, by controlling the respective concentrations of the magnesium salt aqueous solution and the dicyandiamide aqueous solution and the volume ratio of the two within the above ranges, Mg²⁺ and the dicyandiamide can have a suitable ratio, which is more conducive to obtaining a magnetic thermally conductive catalyst having excellent catalytic performance and ensuring that the full catalytic degradation of an organic waste can be realized.

In some embodiments of the present disclosure, a ratio of a mass of the iron salt to a total volume of the magnesium salt aqueous solution and the dicyandiamide aqueous solution is in a range of (0.05-0.15) g:(1-2) L. In the present disclosure, by controlling the ratio of the mass of the iron salt to the total volume of the magnesium salt aqueous solution and the dicyandiamide aqueous solution within the above range, Mg, carbon, and nitrogen doped in the magnetic thermally conductive catalyst can have a suitable ratio, thereby ensuring that the magnetic thermally conductive catalyst has excellent catalytic performance, which is conducive to realizing the full catalytic degradation of an organic waste.

In some embodiments of the present disclosure, the mixing is conducted by stirring. There are no special requirements for the specific parameters of the stirring, as long as the raw materials can be uniformly mixed.

In some embodiments of the present disclosure, the drying is conducted by stirring in an oil bath at 85° C. until the moisture is completely evaporated. In the present disclosure, by adopting the above drying mode, Fe²⁺, Fe³⁺, and Mg²⁺ are more conducive to uniformly complexing on the dicyandiamide molecule to form a uniform iron-magnesium-dicyandiamide complex, and Mg, carbon, and nitrogen are more conducive to uniformly doping in Fe₃O₄ to effectively improve the catalytic effect of the magnetic thermally conductive catalyst, thereby ensuring that the full catalytic degradation of an organic waste can be realized.

In some embodiments of the present disclosure, after the iron-magnesium-dicyandiamide complex is obtained, the iron-magnesium-dicyandiamide complex is calcined to obtain the carbon and nitrogen-doped Fe₃O₄—MgO catalyst.

In some embodiments of the present disclosure, the calcining is conducted at a temperature of 500° C. to 600° C., and preferably 550° C.; and the calcining is conducted for 2.5 h to 3.5 h, and preferably 2 h. In the present disclosure, by controlling the temperature and time of the calcining within the above ranges, the dicyandiamide can be fully decomposed to produce a carbon-nitrogen skeleton, and at the same time, Fe²⁺, Fe³⁺, and Mg²⁺ can be fully converted to Fe₃O₄ and MgO.

In some embodiments of the present disclosure, the calcining is conducted in a vacuum. In the present disclosure, by calcining in a vacuum, C and N in the dicyandiamide can be prevented from oxidizing, and oxygen in nitrate in iron and magnesium salts can be combined with metals and converted to Fe₃O₄ and MgO.

In the present disclosure, the catalytic degradation is conducted at a temperature of 200° C. to 250° C., and preferably 210° C. to 240° C.; and the catalytic degradation is conducted for 15 h to 24 h, and preferably 16 h to 23 h. In the present disclosure, by controlling the temperature of the catalytic degradation within the above range, the organic waste can be activated, the friction and collision among molecules can be accelerated, and at the same time, H₂O can be activated under the action of the magnetic thermally conductive catalyst to form OH⁻ free radicals and oxygen free radicals to effectively promote the full decomposition, thereby realizing the rapid, effective, and harmless on-site disposal of the organic waste.

In some embodiments of the present disclosure, a heating mode for the catalytic degradation is light wave irradiation. In some embodiments of the present disclosure, the light wave irradiation is conducted with a wavelength of 170 nm to 180 nm and an intensity of 60 mW/m² to 70 mW/m², and preferably 65 mW/m². In the present disclosure, the light wave irradiation is stopped after reaching the temperature of the catalytic degradation under the light wave irradiation, and the light wave irradiation is automatically started after being lower than the temperature of the catalytic degradation. In the present disclosure, the heating is carried out by light wave irradiation. On the one hand, the magnetic thermally conductive catalyst can absorb the nanowaves emitted by light waves, and quickly transfer heat to the inside of the organic waste, thereby accelerating the catalytic degradation of the organic waste. On the other hand, it is convenient to keep the temperature of the catalytic degradation constant to ensure the continuous catalytic degradation, so that the organic waste can undergo full catalytic degradation. In addition, it is more environmentally friendly to provide a heat source by the light wave irradiation.

In the present disclosure, after the catalytically degraded gas, the catalytically degraded suspended particulate matter, and the catalytically degraded solid are obtained, the catalytically degraded gas and the catalytically degraded suspended particulate matter are purified, then discharged, and the catalytically degraded solid is subjected to magnetic separation to obtain an ash and a recovered magnetic thermally conductive catalyst.

In some embodiments of the present disclosure, the catalytically degraded gas includes two or more selected from the group consisting of moisture, CO, CO₂, NOₓ, SO₂, HCl, and a tar gas.

In some embodiments of the present disclosure, purifying the catalytically degraded gas includes: subjecting the catalytically degraded gas to washing spray, electric tar capture, and low-temperature plasma treatment successively. There are no special requirements for each operation of the purifying, and conventional operations in the art can be adopted to ensure that the catalytically degraded gas can be effectively purified to meet emission standards.

In some embodiments of the present disclosure, the catalytically degraded solid includes an ash and a magnetic thermally conductive catalyst.

There are no special requirements for the magnetic separation operation of the magnetic thermally conductive catalyst, and the magnetic separation well known to those skilled in the art may be adopted to realize the recovery of the magnetic thermally conductive catalyst.

The method for catalytic degradation of an organic waste provided by the present disclosure can quickly realize the catalytic degradation of an organic waste at a relatively-low temperature without producing harmful substances such as dioxins, and can also realize the on-site disposal of an organic waste in daily life. The method is simple, easy to implement, and cost-effective, and does not require the long-distance transportation of rural wastes to a specific waste disposal station in a city. Moreover, the magnetic thermally conductive catalyst can be recovered based on its magnetic characteristics, thereby realizing the recycling of the magnetic thermally conductive catalyst.

The technical solutions of the present disclosure will be clearly and completely described below with reference to the examples of the present disclosure. Apparently, the examples described are merely a part and not all of the examples of the present disclosure. All other examples obtained by those of ordinary skill in the art based on the examples of the present disclosure without creative efforts shall fall within the scope of the present disclosure.

### Example 1

A method for catalytic degradation of an organic waste was performed by the following steps:

(1) Under a condition of a closed micro-oxygen environment, an organic waste was mixed with a magnetic thermally conductive catalyst, obtaining a mixture, and the mixture was subjected to catalytic degradation, obtaining a catalytically degraded gas, a catalytically degraded suspended particulate matter, and a catalytically degraded solid.

Wherein the closed micro-oxygen environment had an oxygen concentration of 0.03 ml/L; a mass ratio of the organic waste to the magnetic thermally conductive catalyst was 110:1; the organic waste was a mixture of a waste plastic, a waste paper, and a waste nylon material; and the magnetic thermally conductive catalyst was a carbon and nitrogen-doped Fe₃O₄—MgO catalyst.

The carbon and nitrogen-doped Fe₃O₄—MgO catalyst was prepared by the following steps:

1) An iron salt powder, a magnesium salt aqueous solution, and a dicyandiamide aqueous solution were mixed, obtaining a mixture, and then the mixture was dried, obtaining an iron-magnesium-dicyandiamide complex. Specifically, an Fe(NO₃)₂ aqueous solution and an Fe(NO₃)₃ aqueous solution were mixed, obtaining a mixed solution, and then the mixed solution was subjected to ultrasonic treatment for 30 min and dried in an oven at 105° C., obtaining a mixture of 0.1 mol/L Fe(NO₃)₂ and 0.1 mol/L Fe(NO₃)₃, i.e., an iron salt powder. Wherein a volume ratio of the Fe(NO₃)₂ aqueous solution to the Fe(NO₃)₃ aqueous solution was 2:3; the magnesium salt aqueous solution was a 0.2 mol/L Mg(NO₃)₂ aqueous solution; the dicyandiamide aqueous solution had a concentration of 0.1 mol/L; a volume ratio of the Mg(NO₃)₂ aqueous solution to the dicyandiamide aqueous solution was 1:5; a ratio of a mass of the iron salt powder to a total volume of the magnesium salt aqueous solution and the dicyandiamide aqueous solution was 0.1 g:1 L; the mixing was conducted by stirring; and the drying was conducted by stirring in an oil bath at 85° C. until the moisture was completely evaporated.

2) The iron-magnesium-dicyandiamide complex obtained in step 1) was calcined at 550° C. for 3 h, obtaining the carbon and nitrogen-doped Fe₃O₄—MgO catalyst.

The catalytic degradation was conducted at 200° C. for 18 h; a heating for the catalytic degradation was carried out by light wave irradiation; the light wave irradiation was stopped after reaching the temperature of the catalytic degradation under the light wave irradiation, and was automatically started after being lower than the temperature of the catalytic degradation; and the light wave irradiation was conducted with a wavelength of 180 nm and an intensity of 65 mW/m².

(2) The catalytically degraded gas and the catalytically degraded suspended particulate matter obtained in step (1) were purified, then discharged, and the catalytically degraded solid obtained in step (1) was subjected to magnetic separation, obtaining an ash and a recovered magnetic thermally conductive catalyst. The catalytically degraded gas was a mixture of moisture, CO, CO₂, NOₓ, SO₂, and a tar gas; the catalytically degraded solid was a mixture of the ash and the recovered magnetic thermally conductive catalyst; and purifying the catalytically degraded gas was conducted by subjecting the catalytically degraded gas to washing spray, electric capture tar, and low-temperature plasma treatment successively.

### Example 2

A method for catalytic degradation of an organic waste was performed by the following steps:

(1) Under a condition of a closed micro-oxygen environment, an organic waste was mixed with a magnetic thermally conductive catalyst, obtaining a mixture, and the mixture was subjected to catalytic degradation, obtaining a catalytically degraded gas, a catalytically degraded suspended particulate matter, and a catalytically degraded solid.

Wherein the closed micro-oxygen environment had an oxygen concentration of 0.08 ml/L; a mass ratio of the organic waste to the magnetic thermally-conductive catalyst was 95:1; the organic waste was a mixture of a waste plastic and a kitchen waste; and the magnetic thermally conductive catalyst was a carbon and nitrogen-doped Fe₃O₄—MgO catalyst.

The carbon and nitrogen-doped Fe₃O₄—MgO catalyst was prepared by the following steps:

1) An iron salt powder, a magnesium salt aqueous solution, and a dicyandiamide aqueous solution were mixed, obtaining a mixture, and then the mixture was dried, obtaining an iron-magnesium-dicyandiamide complex. Specifically, an Fe(NO₃)₂ aqueous solution and an Fe(NO₃)₃ aqueous solution were mixed, obtaining a mixed solution, and then the mixed solution was subjected to ultrasonic treatment for 30 min and dried in an oven at 105° C., obtaining a mixture of 0.1 mol/L Fe(NO₃)₂ and 0.1 mol/L Fe(NO₃)₃, i.e., an iron salt powder. Wherein a volume ratio of the Fe(NO₃)₂ aqueous solution to the Fe(NO₃)₃ aqueous solution was 1:2; the magnesium salt aqueous solution was a 0.2 mol/L Mg(NO₃)₂ aqueous solution; the dicyandiamide aqueous solution had a concentration of 0.1 mol/L; a volume ratio of the Mg(NO₃)₂ aqueous solution to the dicyandiamide aqueous solution was 2:5; a ratio of a mass of the iron salt powder to a total volume of the magnesium salt aqueous solution and the dicyandiamide aqueous solution was 0.1 g:1.5 L; the mixing was conducted by stirring; and the drying was conducted by stirring in an oil bath at 85° C. until the moisture was completely evaporated.

2) The iron-magnesium-dicyandiamide complex obtained in step 1) was calcined at 550° C. for 3 h, obtaining the carbon and nitrogen-doped Fe₃O₄—MgO catalyst.

The catalytic degradation was conducted at 220° C. for 21 h; a heating for the catalytic degradation was carried out by light wave irradiation; the light wave irradiation was stopped after reaching the temperature of the catalytic degradation under the light wave irradiation, and was automatically started after being lower than the temperature of the catalytic degradation; and the light wave irradiation was conducted with a wavelength of 170 nm and an intensity of 65 mW/m².

(2) The catalytically degraded gas and the catalytically degraded suspended particulate matter obtained in step (1) were purified, then discharged, and the catalytically degraded solid obtained in step (1) was subjected to magnetic separation, obtaining an ash and a recovered magnetic thermally conductive catalyst; the catalytically degraded gas was a mixture of moisture, CO, CO₂, NOₓ, SO₂, and a tar gas; the catalytically degraded solid was a mixture of the ash and the recovered magnetic thermally conductive catalyst; and purifying the catalytically degraded gas was conducted by subjecting the catalytically degraded gas to washing spray, electric capture tar, and low-temperature plasma treatment successively. The magnetic thermally-conductive catalyst was recovered through the magnetic separation.

### Example 3

A method for catalytic degradation of an organic waste was was performed by the following steps:

(1) Under conditions of a closed micro-oxygen environment and light wave irradiation, an organic waste was mixed with a magnetic thermally conductive catalyst, obtaining a mixture, and the mixture was subjected to catalytic degradation, obtaining a catalytically degraded gas, a catalytically degraded suspended particulate matter, and a catalytically degraded solid.

Wherein the closed micro-oxygen environment had an oxygen concentration of 0.08 ml/L; a mass ratio of the organic waste to the magnetic thermally conductive catalyst was 100:3; the organic waste was a mixture of a waste plastic, a waste paper, a kitchen waste, a waste wood product, and a waste nylon material; and the magnetic thermally conductive catalyst was a carbon and nitrogen-doped Fe₃O₄—MgO catalyst.

The carbon and nitrogen-doped Fe₃O₄—MgO catalyst was prepared by the following steps:

1) An iron salt powder, a magnesium salt aqueous solution, and a dicyandiamide aqueous solution were mixed, obtaining a mixture, and then the mixture was dried. obtaining an iron-magnesium-dicyandiamide complex. Specifically, an Fe(NO₃)₂ aqueous solution and an Fe(NO₃)₃ aqueous solution were mixed, obtaining a mixed solution, and then the mixed solution was subjected to ultrasonic treatment for 30 mi, and dried in an oven at 105° C., obtaining a mixture of 0.1 mol/L Fe(NO₃)₂ and 0.1 mol/L Fe(NO₃)₃, i.e., an iron salt powder. Wherein a volume ratio of the Fe(NO₃)₂ aqueous solution to the Fe(NO₃)₃ aqueous solution was 1:2; the magnesium salt aqueous solution was a 0.2 mol/L Mg(NO₃)₂ aqueous solution; the dicyandiamide aqueous solution had a concentration of 0.1 mol/L; a volume ratio of the Mg(NO₃)₂ aqueous solution to the dicyandiamide aqueous solution was 2:5; a ratio of a mass of the iron salt powder to a total volume of the magnesium salt aqueous solution and the dicyandiamide aqueous solution was 0.1 g:1.5 L; the mixing was conducted by stirring; and the drying was conducted by stirring in an oil bath at 85° C. until the moisture was completely evaporated.

2) The iron-magnesium-dicyandiamide complex obtained in step 1) was calcined at 550° C. for 3 h, obtaining the carbon and nitrogen-doped Fe₃O₄—MgO catalyst.

The catalytic degradation was conducted at 230° C. for 23 h; a heating for the catalytic degradation was carried out by light wave irradiation; the light wave irradiation was stopped after reaching the temperature of the catalytic degradation under the light wave irradiation, and was automatically started after being lower than the temperature of the catalytic degradation; and the light wave irradiation was conducted with a wavelength of 180 nm and an intensity of 65 mW/m².

(2) The catalytically degraded gas and the catalytically degraded suspended particulate matter obtained in step (1) were purified, then discharged, and the catalytically degraded solid obtained in step (1) was subjected to magnetic separation, obtaining an ash and a recovered magnetic thermally conductive catalyst; the catalytically degraded gas was a mixture of moisture, CO, CO₂, NOₓ, SO₂, and a tar gas; the catalytically degraded solid was a mixture of the ash and the recovered magnetic thermally conductive catalyst; and purifying the catalytically degraded gas was conducted by subjecting the catalytically degraded gas to washing spray, electric capture tar, and low-temperature plasma treatment successively. The magnetic thermally-conductive catalyst was recovered through the magnetic separation.

Emission standards for the catalytically degraded gases, the catalytically degraded suspended particulate matters, and the ash in the catalytically degraded solids obtained after catalytic degradation in Examples 1 to 3 can be found in the “Standard for Pollution control on the Municipal Solid Waste Incineration” (GB 18485-2014). The detection results of the pollutant contents in the catalytic degradation products obtained in Examples 1 to 3 are shown in Table 1.

TABLE 1
Detection results of the pollutant contents in the catalytic
degradation products obtained in Examples 1 to 3

| Pollutant type | Example 1 | Example 2 | Example 3 |
|---|---|---|---|
| Suspended particulate matter | 25 | 20 | 18 |
| NOₓ/(mg/m³) | 100 | 110 | 90 |
| SO₂/(mg/m³) | 50 | 45 | 30 |
| HCl/(mg/m³) | <10 | 21 | 10 |
| CO/(mg/m³) | 80 | 75 | 70 |
| Hg and a compound thereof (a content of the | 0.02 | 0.01 | 0.01 |
| compound is calculated based on Hg)/(mg/m³) | | | |
| Cadmium, thallium, and a compound thereof (a | 0.03 | 0.02 | 0.02 |
| content of the compound is calculated based on | | | |
| Cd + Tl)/(mg/m³) | | | |
| Antimony, arsenic, lead, chromium, cobalt, copper, | 0.2 | <0.1 | 0.1 |
| manganese, nickel, and a compound thereof (a | | | |
| content of the compound is calculated based on | | | |
| Sb + As + Pb + Cr + Co + Cu + Mn + Ni)/(mg/m³) | | | |
| Dioxin/(ngTEQ/m³) | 0.002 | 0.003 | 0.001 |
| Ash ignition loss/% | 2.8 | 2.8 | 2.6 |

It can be seen from Table 1 that, when the method provided by the present disclosure is used for catalytic degradation of an organic waste, the ash ignition loss is in a range of 2.6% to 2.8%, and when the final product is discharged, the pollutant contents in the final products are as follows: suspended particulate matter: 18 mg/m³ to 25 mg/m³; NOₓ: 90 mg/m³ to 110 mg/m³; SO₂: 30 mg/m³ to 50 mg/m³; HCl: less than or equal to 21 mg/m³; CO: 70 mg/m³ to 80 mg/m³; Hg and a compound thereof (a content of the compound is calculated in terms of Hg): 0.01 mg/m³ to 0.02 mg/m³; cadmium, thallium, and a compound thereof (a content of the compound is calculated in terms of Cd+Tl): 0.02 mg/m³ to 0.03 mg/m³; antimony, arsenic, lead, chromium, cobalt, copper, manganese, nickel, and a compound thereof (a content of the compound is calculated in terms of Sb+As+Pb+Cr+Co+Cu+Mn+Ni): less than or equal to 0.2 mg/m³; and dioxin: 0.001 ngTEQ/m³ to 0.03 ngTEQ/m³. The pollutant contents in the catalytic degradation products all meet the emission standards in the “Standard for Pollution control on the Municipal Solid Waste Incineration” (GB 18485-2014).

In summary, the method for catalytic degradation of an organic waste provided by the present disclosure can quickly realize the catalytic degradation of an organic waste at a relatively-low temperature without producing harmful substances such as dioxins, and can also realize the on-site disposal of an organic waste in daily life. The method is simple, easy to implement, and cost-effective.

The above are merely the preferred embodiments of the present disclosure. It should be understood that several improvements and modifications could be made by those of ordinary skill in the art without departing from the principle of the present disclosure, and these improvements and modifications should be deemed as falling within the scope of the present disclosure.

1-10. (canceled)

11. A method for catalytic degradation of an organic waste, comprising:
step (1) under a condition of a closed micro-oxygen environment, mixing the organic waste with a magnetic thermally conductive catalyst to obtain a mixture, and subjecting the mixture to catalytic degradation to obtain a catalytically degraded gas, a catalytically degraded suspended particulate matter, and a catalytically degraded solid; and
step (2) purifying the catalytically degraded gas and the catalytically degraded suspended particulate matter obtained in step (1), then discharging, and subjecting the catalytically degraded solid obtained in step (1) to magnetic separation to obtain an ash and a recovered magnetic thermally conductive catalyst;
wherein the catalytic degradation is conducted at a temperature of 200° C. to 250° C. for 15 h to 24 h.

12. The method of claim 1, wherein in step (1), the closed micro-oxygen environment has an oxygen concentration of 0.01 mL/L to 0.1 mL/L.

13. The method of claim 11, wherein in step (1), a mass ratio of the organic waste to the magnetic thermally conductive catalyst is in a range of (90-110):(1-5).

14. The method of claim 11, wherein in step (1), the organic waste comprises one or more selected from the group consisting of a waste plastic, a waste paper, a kitchen waste, a waste wood product, and a waste nylon material.

15. The method of claim 11, wherein in step (1), the magnetic thermally conductive catalyst is a carbon and nitrogen-doped Fe₃O₄—MgO catalyst.

16. The method of claim 15, wherein the carbon and nitrogen-doped Fe₃O₄—MgO catalyst is prepared by a process comprising the following steps:
Step 1) mixing an iron salt, a magnesium salt aqueous solution, and a dicyandiamide aqueous solution to obtain a mixture, and then drying the mixture to obtain an iron-magnesium-dicyandiamide complex; and
Step 2) calcining the iron-magnesium-dicyandiamide complex obtained in step 1) to obtain the carbon and nitrogen-doped Fe₃O₄—MgO catalyst.

17. The method of claim 16, wherein in step 1), a ratio of a mass of the iron salt to a total volume of the magnesium salt aqueous solution and the dicyandiamide aqueous solution is in a range of (0.05-0.14) g:(1-2) L.

18. The method of claim 16, wherein in step 2), the calcining is conducted at a temperature of 500° C. to 600° C. for 2.5 h to 3.5 h.

19. The method of claim 11, wherein in step (1), a heating of the catalytic degradation is carried out by light wave irradiation, and the light wave irradiation is conducted with a wavelength of 170 nm to 180 nm and an intensity of 60 mW/m² to 70 mW/m².

20. The method of claim 11, wherein in step (2), purifying the catalytically degraded gas comprises subjecting the catalytically degraded gas to washing spray, electric capture tar, and low-temperature plasma treatment successively.

21. The method of claim 13, wherein in step (1), the organic waste comprises one or more selected from the group consisting of a waste plastic, a waste paper, a kitchen waste, a waste wood product, and a waste nylon material.

22. The method of claim 13, wherein in step (1), the magnetic thermally conductive catalyst is a carbon and nitrogen-doped Fe₃O₄—MgO catalyst.
